(19) United States
(12) Patent Application Publication
(10) Pub. No.: US 2026/0293935 A1
(43) Pub. Date: Oct. 1, 2026

(54) RUMINANT FEED ADDITIVE COMPOSITIONS

(71) Applicant: INTERNATIONAL N&H DENMARK APS, Kongens Lyngby (DK)

(72) Inventors: Rubén GARCIA-GONZÁLEZ, Silla Valencia (ES); Marion BERNARDEAU, Neuilly-sur-Seine (FR); Leon MARCHAL, Oegstgeest (NL)

(21) Appl. No.: 19/478,739

(22) PCT Filed: Apr. 29, 2024
(86) PCT No.: PCT/US2024/026807

§ 371 Date: Oct. 24, 2025

Related U.S. Application Data
(60) Provisional application No. 63/462,697, filed on Apr. 28, 2023.

(51) Int. Cl. A23K 20/189; A23K 10/18; A23K 50/10

(52) U.S. Cl. CPC A23K 20/189; A23K 10/18; A23K 50/10

(57) ABSTRACT

Provided herein, inter alia, are ruminant feed or feed additive compositions comprising one or more compounds that increase hydrogen production in a ruminant animal (such as, without limitation, 3-Nitrooxypropanol (3NOP)) and one or more acetogenic bacteria as well as methods for use of the same to reduce methane emissions in ruminant animals while simultaneously improving animal performance.

### CROSS-REFERENCE TO RELATED APPLICATIONS

This application claims priority to U.S. Provisional Patent Application No. 63/462,697, filed Apr. 28, 2023, the disclosure of which is hereby incorporated by reference herein in its entirety.

### FIELD OF THE INVENTION

Provided herein, inter alia, are methods and compositions for reducing of methane emission in ruminant animals while simultaneously improving animal performance on one or more metrics.

### BACKGROUND

The main end-products of ruminal fermentation are volatile fatty acids (VFA), microbial protein and gas (methane (CH₄), carbon dioxide (CO₂), and hydrogen (H₂)). VFA and microbial protein are absorbed in the digestive system and incorporated into the metabolism of the animal host. However, some fermentation end-products (CO₂ and H₂) are not absorbed in the rumen. In this case, CO₂ and H₂ are consumed by methanogenic archaea (MA) to produce methane, which the animals release into the atmosphere, where it acts as a greenhouse gas. It is considered that around 2% to 12% of the total energy consumed by ruminants can be metabolized to CH₄. The environmentally deleterious release of methane into the atmosphere combined with a loss of potential energy for the animal represent two major global ruminant agricultural challenges.

Approaches to mitigate ruminal methane emissions and enhance livestock productivity aiming for sustainable animal production systems currently rely on (1) rumen inhibitors of the methanogenesis pathway and (2) rumen modifiers.

Among rumen inhibitors, 3-nitrooxypropanol, abbreviated 3NOP, developed by DSM (Bovaer®; U.S. Pat. Nos. 9,365,489 and 10,154,981, incorporated by reference herein in their entireties), is an organic compound with the formula HOCH₂CH₂CH₂ONO₂ (mononitrate ester of 1,3 propanediol) which inhibits the enzyme methyl coenzyme M reductase (MCR). MCR catalyzes the final step in the methanogenesis pathway, reducing methane excretion by 30% when fed to a ruminant animal.

While being successful in reducing methane, a meta-analysis of all available animal data following supplementation with 3NOP only showed modest increases in animal growth and production. What is needed, therefore, is a way to reduce or inhibit the excretion of methane from ruminant while, at the same time, improving the performance of ruminant production.

The subject matter disclosed herein addresses this need and provides additional benefits as well.

### SUMMARY

Provided herein, inter alia, are ruminant feed or feed additive compositions comprising one or more compounds that increase hydrogen production in a ruminant animal (such as, without limitation, 3-Nitrooxypropanol (3NOP)) and one or more acetogenic bacteria as well as methods for use of the same to reduce methane emissions in ruminant animals while simultaneously improving animal performance.

Accordingly, in some aspects, provided herein ruminant feed additive or feed compositions comprising (a) one or more rumen inhibitor compounds; and (b) (1) one or more acetogenic bacteria; and/or (2) one or more compounds that promote hydrogen consumption in the rumen. In some embodiments, the rumen inhibitor compound comprises one or more of a nitrooxy compound, a coenzyme M analog, a pterin compound, a hydroxymethylglutaryl-CoA reductase inhibitor, an antimicrobial peptide, or a plant secondary metabolite. In some embodiments of any of the embodiments disclosed herein, the rumen inhibitor compound comprises 3-Nitrooxypropanol (3NOP) or coenzyme-M analogue. In some embodiments of any of the embodiments disclosed herein, the one or more acetogenic bacteria is one or more bacteria selected from the group consisting of Acetobacterium bakii, Blautia hydrogenotrophica, Blautia producta, Blautia schinkii, Clostridium autoethanogenum, Clostridium carboxidivorans, Clostridium coskii, Clostridium ljungdahlii, Clostridium scatologenes, Sporomusa acidovorans, Eubacterium limosum, Acetobacterium woodii, Sporomusa silvacetica, Moorella thermoacetica, Acetitomaculum ruminis, Ruminococcus productus, and Clostridium magnum. In some embodiments of any of the embodiments disclosed herein, the one or more compounds that promote hydrogen consumption in the rumen comprises one or more of a nitrate, sulfate, nitrocompound, or propionate precursor. In some embodiments of any of the embodiments disclosed herein the feed or feed additive composition further comprises one or more enzymes. In some embodiments, the enzyme comprises one or more of a glucoamylase, xylanase, amylase, phytase, beta-glucanase, fucosidase, and/or protease.

In other aspects, provided herein is a method for reducing the production of methane emanating from the digestive activities of ruminants and/or for improving ruminant animal performance comprising orally administering to the animal an effective amount any of the feed additive or feed compositions disclosed herein. In some embodiments, the ruminant animal is selected from the group consisting of: beef cattle, dairy cattle, veal, goats, sheep, giraffes, American Bison, European bison, yaks, water buffalo, deer, camels, alpacas, llamas, wildebeest, antelope, pronghorn, and nilgai. In some embodiments of any of the embodiments disclosed herein, the hydrogen concentration in the rumen of the animal is less than 5%. In some embodiments of any of the embodiments disclosed herein, the feed additive or feed composition is not pretreated using wet explosion pretreatment.

In additional aspects, provided herein is a method for producing a feed additive or feed composition comprising combining (a) one or more rumen inhibitor compounds; and (b) (1) one or more acetogenic bacteria; and/or (2) one or compounds that promote hydrogen consumption in the rumen. In some embodiments, the rumen inhibitor compound comprises one or more of a nitrooxy compound, a coenzyme M analog, a pterin compound, a hydroxymethylglutaryl-CoA reductase inhibitor, an antimicrobial peptide, or a plant secondary metabolite. In some embodiments of any of the embodiments disclosed herein, the rumen inhibitor compound comprises 3-Nitrooxypropanol (3NOP) or coenzyme-M analogue. In some embodiments of any of the embodiments disclosed herein, the one or more acetogenic bacteria is one or more bacteria selected from the group consisting of Acetobacterium bakii, Blautia hydrogenotrophica, Blautia producta, Blautia schinkii, Clostridium autoethanogenum, Clostridium carboxidivorans, Clostridium coskii, Clostridium ljungdahlii, Clostridium scatologenes, Sporomusa acidovorans, Eubacterium limosum, Acetobacterium woodii, Sporomusa silvacetica, Moorella thermoacetica, Acetitomaculum ruminis, Ruminococcus productus, and Clostridium magnum. In some embodiments of any of the embodiments disclosed herein, the one or more compounds that promote hydrogen consumption in the rumen comprises one or more of a nitrate, sulfate, nitrocompound, or propionate precursor. In some embodiments of any of the embodiments disclosed herein, the method further comprises combining one or more enzyme with the feed additive or feed composition. In some embodiments, the enzyme comprises a glucoamylase and/or a phytase. In some embodiments of any of the embodiments disclosed herein, the method further comprises packaging the feed additive or feed composition. In some embodiments of any of the embodiments disclosed herein, the feed additive or feed composition is not pretreated using wet explosion pretreatment.

Each of the aspects and embodiments described herein are capable of being used together, unless excluded either explicitly or clearly from the context of the embodiment or aspect.

Throughout this specification, various patents, patent applications and other types of publications (e.g., journal articles, electronic database entries, etc.) are referenced. The disclosure of all patents, patent applications, and other publications cited herein are hereby incorporated by reference in their entirety for all purposes.

### BRIEF DESCRIPTION OF THE FIGURES

FIG. 1 depicts a chart displaying the effects of Blautia producta (B. prod.), freeze-dried Asparagopsis taxiformis (FDAT), and 3NOP, alone or in combinations, on hydrogen, methane, total gas, and VFA production from in vitro rumen cultures. Superscript letters which differ indicate statistical significance.

FIG. 2 depicts a chart displaying the effects of Acetobacterium woodii (A. woo.), freeze-dried Asparagopsis taxiformis (FDAT), and 3NOP, alone or in combinations, on hydrogen, methane, total gas, and VFA production from in vitro rumen cultures. Superscript letters which differ indicate statistical significance.

### DETAILED DESCRIPTION

Ruminants are mammals of the order Artiodactyla that digest plant-based food by initially softening it within the animal's first stomach, known as the rumen, then regurgitating the semi-digested mass, now known as cud, and chewing it again. The process of chewing the cud to further break down plant matter and stimulate digestion is called “ruminating” or “rumination.”

Methane is produced as a natural consequence of the anaerobic fermentation which occurs during rumination. Methane production represents an energy loss to the host animal (i.e., the carbon that could be used to produce glucose for metabolic needs is expelled into the atmosphere as CH₄). Carbohydrate makes up 70 to 80% of the dry matter in a typical ruminant ration and, despite this, the absorption of carbohydrates from the ruminant gastrointestinal tract is normally very limited. The reason for this is the extensive fermentation of carbohydrates in the rumen resulting in production of acetate, propionate and butyrate as the main products. These products are known as volatile fatty acids (VFAs).

Besides the energy loss, methane is also a greenhouse gas, which is many times more potent than carbon dioxide (CO₂). Its concentration in the atmosphere has doubled over the last century and continues to increase alarmingly. Ruminants are major contributors to the biogenic methane formation. Disrupting or limiting the methanogenesis that takes place during ruminal fermentation carries with it the prospect of lessening greenhouse emissions which negatively contribute to climate change.

Unfortunately, studies have shown that disruption of methanogenesis has a negative effect on overall rumen fermentation and that the H₂-scavenging function of the methanogens are important for a stable rumen function (Murali et al., 2021). Inhibition of methanogenesis in an artificial rumen bioreactor has been studied extensively, mainly for purposes of avoiding energy loss in the animal (Van Kessel, 1996). These studies have shown that an increase in H₂ partial pressure is also, to a certain extent, inhibitory for the overall conversion in the rumen (Ahring et al., 2018). This might explain why inhibition of the methanogenesis by rumen inhibitors such as 3NOP fail to significantly capture the energy from CH₄ production inhibition and translate it into animal performance, such as improved weight gain (Anuraga Jayanegara et al., 2018).

Without being bound to theory, it is hypothesized that a rumen inhibitor (e.g., 3NOP), by inhibiting the methanogenesis circle, concomitantly affects the hydrogen cycle in the rumen leading to a detrimental accumulation of H₂ for ruminal fermentation. Consequently, the inventors of the instant application have surprisingly found that a combination of rumen inhibitor (such as, but not limited to 3NOP or coenzyme-M analogue) and hydrogen scavenger (such as, without limitation, one or more acetogenic microorganisms) is able to maximize the potential of a rumen inhibitor by minimizing/balancing the side negative effects of blocking methanogenesis (i.e., increased production of H₂). It is believed, again without being bound to theory, that such a combination will restore a balanced H₂ cycle and optimal fermentation within the rumen.

Thus, the invention provides significant reduction of energy loss captured by significant enhancement of performances of animal production and similar or better CH₄ reduction compared to supplementation with the rumen inhibitor alone.

### I. Definitions

The term “ruminants” or “ruminant animals” as used herein refers to mammals, both males and females, that are able to acquire nutrients from plant-based food through fermentation in a specialized stomach chamber prior to digestion, principally through bacterial actions. The process typically requires regurgitation of fermented ingesta (known as cud) and chewing it again. The process of rechewing the cud to further break down plant matter and stimulate digestion is called “rumination”. The primary difference between ruminant animals and non-ruminant animals is that ruminant animals have a three or four-chambered stomach. The group includes, among others, deer, antelopes, buffalo, cattle, sheep, camel, and goat.

The term “lactating ruminant” as used herein refers to a ruminant animal which is capable of producing milk post-parturition.

The term “dairy ruminant” as used herein refers to a ruminant animal, whose milk is used for commercial purposes including the period that the animal is not giving milk.

The terms “rumen inhibitor” or “rumen methane inhibitor” as used interchangeably herein relates to all compounds suitable to reduce the methane emissions in ruminants. Suitable rumen inhibitors include, without limitation, garlic extracts, allicin, chloroform, bromoform, nitrate, nitroethane, lauric acid, lauricidin, marine algae such as the Hawaiian micro-algae Chactoceros, one or more of the compounds displayed in Table 1 or Table 4, or one or more compounds further described below or disclosed in U.S. Pat. Nos. 9,365,489 and 10,154,981, incorporated by reference herein. In other embodiments, the rumen inhibitor is 3-nitrooxypropanol (3NOP) or a coenzyme-M analogue.

As used herein, the term “reducing” in relation to a particular trait, characteristic, feature, biological process, or phenomena refers to a decrease in the particular trait, characteristic, feature, biological process, or phenomena. The trait, characteristic, feature, biological process, or phenomena can be decreased by 5%, 10%, 15%, 20%, 25%, 30%, 35%, 40%, 45%, 50%, 55%, 60%, 65%, 70%, 75%, 80%, 85%, 90%, 95%, 100% or greater than 100%.

As used herein “administer” or “administering” is meant the action of introducing one or more rumen inhibitor, one or more acetogenic bacteria, and/or one or more compounds that promote hydrogen consumption in the rumen to an animal, such as by feeding or by gavage. In one embodiment, a composition is administered to a subject via a water line, from which the animal drinks.

As used herein, “effective amount” means a quantity of a substance (for example, one or more rumen inhibitor, one or more acetogenic bacteria, and/or one or more compounds that promote hydrogen consumption in the rumen) to improve one or more metrics in an animal. Improvement in one or more metrics of an animal (such as, without limitation, any of decreased methane production, increased volatile fatty acid production, improved feed conversion ratio (FCR); improved milk production; improved weight gain; improved feed efficiency; improved gut microbiome status; and/or improved carcass quality can be measured as described herein or by other methods known in the art. An effective amount can be administered to the animal by providing access to feed and/or water containing the substance. Additionally, substances (e.g., one or more rumen inhibitor, one or more acetogenic bacteria, and/or one or more compounds that promote hydrogen consumption in the rumen) can also be administered in one or more doses. Also, in some embodiments, an effective amount of some substances (e.g., rumen inhibitor, and/or one or more compounds that promote hydrogen consumption in the rumen) can be administered in feed or as a component of a feed and other substances (e.g. one or more acetogenic bacteria) can be administered by water line.

A “feed” and a “food,” respectively, means any natural or artificial diet, meal or the like or components of such meals intended or suitable for being eaten, taken in, digested, by a non-human animal and a human being, respectively. As used herein, the term “food” is used in a broad sense- and covers food and food products for humans as well as food for non-human animals (i.e. a feed).

As used herein, the term “feed” is used synonymously herein with “feedstuff.” Feed broadly refers to a material, liquid or solid, that is used for nourishing an animal, and for sustaining normal or accelerated growth of an animal including newborns or young and developing animals. The term includes a compound, preparation, mixture, or composition suitable for intake by an animal (such as, e.g., for poultry such as quail, ducks, turkeys, and chickens). In some embodiments, a feed or feed composition comprises a basal food composition and one or more feed additives or feed additive compositions.

The term “feed additive” as used herein refers to components included for purposes of fortifying basic feed with additional components to promote feed intake, treat or prevent disease, or alter metabolism. In some embodiments, however, the feed additive is formulated for water line delivery to the animal and is not added directly to the feed. Feed additives include pre-mixes. As used herein, the term “feed additive” also refers to a substance which is added to a feed or to water administered in conjunction with a feed. Feed additives may be added to feed for a number of reasons. For instance, to enhance digestibility of the feed, to supplement the nutritional value of the feed, improve the immune defense of the recipient and/or to improve the shelf life of the feed. In some embodiments, the feed additive supplements the nutritional value of the feed and/or improves the immune defense of the recipient. In some embodiments, the feed additive is not for administration to a human.

A “premix,” as referred to herein, may be a composition composed of micro-ingredients such as, but not limited to, one or more of vitamins, minerals, chemical preservatives, antibiotics, fermentation products, and other essential ingredients. Premixes are usually compositions suitable for blending into commercial rations.

The term “animal performance” as used herein may be determined by the feed efficiency and/or milk production and/or weight gain of the animal and/or by the feed conversion ratio and/or by the digestibility of a nutrient in a feed and/or digestible energy or metabolizable energy in a feed and/or by nitrogen retention and/or by animals' ability to avoid the negative effects of diseases or by the immune response of the subject. Performance characteristics may include but are not limited to: body weight; weight gain; mass; body fat percentage; height; body fat distribution; growth; growth rate; milk production; mineral absorption; mineral excretion, mineral retention; bone density; bone strength; feed conversion ratio (FCR); average daily feed intake (ADFI); average daily gain (ADG) retention and/or a secretion of any one or more of copper, sodium, phosphorous, nitrogen and calcium; amino acid retention or absorption; mineralization, bone mineralization carcass yield and carcass quality. Animal performance can also be as measured by increased ruminal acetate/propionate ratio, decreased feed conversion ratio, increased feed intake, increased weight gain, increased carcass yield, or increased milk or milk protein content and/or yield, or increased milk fat content and/or yield.

As used herein, the term “feed efficiency” refers to the amount of milk production or weight gain in an animal that occurs when the animal is fed ad-libitum or a specified amount of food during a period of time. By “increased feed efficiency” it is meant that the use of a feed additive composition according the present invention in feed or in drinking water via water line delivery results in an increased milk production or weight gain per unit of feed intake compared with an animal fed without said feed additive composition being present.

As used herein, “feed conversion ratio” refers to a measure of a subject's efficiency in converting feed mass into increases of a desired output and is calculated by dividing the mass of the food eaten by the output for a specified period. For example, if an animal is raised for meat (e.g., beef), the output may be the mass gained by the animal. If an animal is raised for another intended purpose (e.g., milk production), the output will be different, such as the amount of milk produced. The term “feed conversion ratio” may be used interchangeably with the terms “feed conversion rate” or “feed conversion efficiency.” By “lower feed conversion ratio” or “improved feed conversion ratio” it is meant that the use of a feed additive composition in feed results in a lower amount of feed being required to be fed to an animal to increase the weight of the animal or to increase the production of milk by a specified amount compared to the amount of feed required to increase the weight of the animal or to increase the production of milk by the same amount when the feed does not comprise said feed additive composition.

The term “direct-fed microbial” (“DFM”) as used herein is source of live (viable) microorganisms that when applied in sufficient numbers can confer a benefit to the recipient thereof, i.e., a probiotic. A DFM can comprise one or more of such microorganisms such as bacterial strains. Non-limiting categories of DFMs include Bacillus, Bifidobacterium, Propionibacterium, Lactic Acid Bacteria, fungi, and yeasts. Thus, the term DFM encompasses one or more of the following: direct fed bacteria, direct fed yeast and combinations thereof. Bacilli are unique, gram-positive rods that form spores. These spores are very stable and can withstand environmental conditions such as heat, moisture and a range of pH. These spores germinate into active vegetative cells when ingested by an animal and can be used in meal and pelleted diets. Lactic Acid Bacteria are gram-positive cocci that produce lactic acid which are antagonistic to some pathogens. Types of Lactic Acid Bacteria include, without limitation, Lactobacillus, Leuconostoc, Pediococcus and Streptococcus. In some embodiments, the DFM is an acetogenic bacteria. In other embodiments, the DFM is a Megasphaera spp., for example M. elsdenii. The terms “probiotic,” “probiotic culture,” and “DFM” are used interchangeably herein and define live microorganisms (including bacteria or yeasts, for example) which, when for example ingested or locally applied in sufficient numbers, beneficially affects the host organism, i.e. by conferring one or more demonstrable benefits (such as a health benefit or balanced gut microbiota benefit) on the host organism such as a digestive and/or performance benefit (such as improved growth and decreased methane emissions). Whilst there are no lower or upper limits for probiotic intake, it has been suggested that at least 10⁶-10¹², for example at least 10⁶-10¹⁰, for example 10⁸-10¹⁰, colony forming units (cfu) as a daily dose are commonly effective to achieve the beneficial effects in a subject.

The term “acetogenic bacteria,” as used herein, refers to a microorganism which is able to perform the Wood-Ljungdahl pathway and thus is able to convert CO, CO₂ and/or hydrogen to acetate. These microorganisms include microorganisms which in their wild-type form do not have a Wood-Ljungdahl pathway but have acquired this trait as a result of genetic modification. These microorganisms may be also known as carboxydotrophic bacteria. Currently, 21 different genera of the acetogenic bacteria are known and these may also include some Clostridia. These bacteria are able to use carbon dioxide or carbon monoxide as a carbon source with hydrogen as an energy source. Further, alcohols, aldehydes, carboxylic acids as well as numerous hexoses may also be used as a carbon source. The reductive pathway that leads to the formation of acetate is referred to as the acetyl-CoA or Wood-Ljungdahl pathway.

The term “CFU” as used herein means “colony forming units” and is a measure of viable cells in which a colony represents an aggregate of cells derived from a single progenitor cell.

As used herein an “animal feed acceptable salt” means any non-toxic salt that, upon administration to a recipient, is capable of providing, either directly or indirectly, a compound or a derivative of a compound described herein. Acids commonly employed to form acceptable salts include inorganic acids such as hydrogen bisulfide, hydrochloric, hydrobromic, hydroiodic, sulfuric and phosphoric acid, as well as organic acids such as para-toluenesulfonic, salicylic, tartaric, bitartaric, ascorbic, maleic, besylic, fumaric, gluconic, glucuronic, formic, glutamic, methanesulfonic, ethanesulfonic, benzenesulfonic, lactic, oxalic, para-bromophenylsulfonic, carbonic, succinic, citric, benzoic and acetic acid, and related inorganic and organic acids. Such animal feed acceptable salts thus include sulfate, pyrosulfate, bisulfate, sulfite, bisulfite, phosphate, monohydrogenphosphate, dihydrogenphosphate, metaphosphate, pyrophosphate, chloride, bromide, iodide, acetate, propionate, decanoate, caprylate, acrylate, formate, isobutyrate, caprate, heptanoate, propiolate, oxalate, malonate, succinate, suberate, sebacate, fumarate, maleate, butyne-1,4-dioate, hexyne-1,6-dioate, benzoate, chlorobenzoate, methylbenzoate, di nitrobenzoate, hydroxybenzoate, methoxybenzoate, phthalate, terephathalate, sulfonate, xylenesulfonate, phenylacetate, phenylpropionate, phenylbutyrate, citrate, lactate, [beta]-hydroxybutyrate, glycolate, maleate, tartrate, methanesulfonate, propanesulfonate, naphthalene-1-sulfonate, naphthalene-2-sulfonate, mandelate and the like salts. Preferred animal feed acceptable acid addition salts include those formed with mineral acids such as hydrochloric acid and hydrobromic acid, and those formed with organic acids such as maleic acid. Suitable cations for forming feed acceptable salts include ammonium, sodium, potassium, calcium, magnesium and aluminum cations, among others.

Certain ranges are presented herein with numerical values being preceded by the term “about.” The term “about” is used herein to provide literal support for the exact number that it precedes, as well as a number that is near to or approximately the number that the term precedes. In determining whether a number is near to or approximately a specifically recited number, the near or approximating unrecited number can be a number which, in the context in which it is presented, provides the substantial equivalent of the specifically recited number. For example, in connection with a numerical value, the term “about” refers to a range of −10% to +10% of the numerical value, unless the term is otherwise specifically defined in context.

As used herein, the singular terms “a,” “an,” and “the” include the plural reference unless the context clearly indicates otherwise.

It is further noted that the claims may be drafted to exclude any optional element. As such, this statement is intended to serve as antecedent basis for use of such exclusive terminology as “solely,” “only” and the like in connection with the recitation of claim elements or use of a “negative” limitation.

It is also noted that the phrase “consisting essentially of,” as used herein, refers to a composition wherein the component(s) recited after the phrase is/are in the presence of other known component(s) in a total amount that is less than 30% by weight of the total composition and which do not contribute to or interfere with the actions or activities of the component(s).

It is further noted that the term “comprising,” as used herein, means including, but not limited to, the component(s) after the term “comprising.” The component(s) after the term “comprising” are required or mandatory, but the composition comprising the component(s) can further include other non-mandatory or optional component(s).

It is also noted that the term “consisting of,” as used herein, means including, and limited to, the component(s) after the term “consisting of.” The component(s) after the term “consisting of” are therefore required or mandatory, and no other component(s) are present in the composition.

It is intended that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

Unless defined otherwise herein, all technical and scientific terms used herein have the same meaning as commonly understood by one of ordinary skill in the art to which this invention pertains.

Other definitions of terms may appear throughout the specification.

### II. Compositions

Provided herein are compositions comprising one or more rumen inhibitor compounds; and one or more acetogenic bacteria; and/or one or more compounds that promote hydrogen consumption in the rumen. The compositions can be used to reduce methane production and improve animal (e.g. ruminant animal) performance.

### A. Rumen Inhibitor Compounds

In some embodiments of the present invention, a rumen inhibitor compound can be any of the compounds disclosed in Table 1.

In other embodiments, a rumen inhibitor compound can be any organic molecule substituted at any position with at least one nitrooxy group, or salts thereof are defined by the following formula (I):

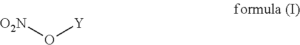

wherein Y is an organic molecule of the following composition: CₐH_{b}O_{d}NₑS_{g}, wherein
a is comprised between 1 and 25, in some embodiments between 1 and 10
b is comprised between 2 and 51, in some embodiments between 2 and 21
d is comprised between 0 and 8, in some embodiments between 0 and 6
e is comprised between 0 and 5, in some embodiments between 0 and 3
g is comprised between 0 and 3, in some embodiments between 0 and 1.

In other embodiments, the organic molecule of formula (I) is of the following composition CₐH_{b}O_{d}NₑS_{g}, wherein
a is comprised between 1 and 10
b is comprised between 2 and 21
d is comprised between 0 and 6
e is comprised between 0 and 3
g is comprised between 0 and 1.

In another embodiment, compounds of formula (I) according to the present invention are compounds, wherein b is comprised between 3 and 51, and in other embodiments, b is comprised between 3 and 21.

In another embodiment, compounds of formula (I) according to the present invention are compounds of formula (II),

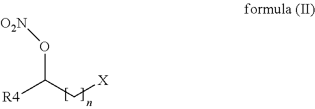

wherein
n is comprised between 0 and 12, in some embodiments comprised between 0 and 6 and,
wherein, if n≠0, the carbon chain is a linear, a cyclic, or branched aliphatic carbon chain which may be non-substituted or substituted with up to 3 hydroxyl-, alkoxy-, amino-, alkylamino-, dialkylamino- or nitrooxy groups, or an alkenyl, or an alkynyl carbon chain mono- or polyunsaturated and in any isomeric form,
R4 is independently, hydrogen or a saturated straight, cyclic or branched chain of an alkyl or alkenyl group containing 1 to 12, preferably 1 to 6 carbon atoms,
X is hydrogen, R5, R5≡N, —OR5, —OCOR5, —NR5R6, —ONO₂, —COOR5, —CONR5R6, —NHSO₂R5, or —SO—NHR5,
R5 and R⁶ are independently, hydrogen, C1-C12 straight, branched or cyclic alkyl chain, non-substituted or substituted with up to 3 hydroxyl-, alkoxy-, amino-, alkylamino-, dialkylamino- or nitrooxy groups, alkenyl, or alkynyl carbon chain which may be mono or polyunsaturated, and in any isomeric form.

For all embodiments of the present invention, it is to be understood that compounds of formula (1) and compounds of formula (II) can be in any isomeric form.

It is to be understood in the above definition of compounds of formula (ID) that when n>2, the carbon chain can be linear or branched at any position along the carbon chain. In addition, the carbon chain can be branched by multiple branches at different positions along the carbon chain. Moreover, when n>3, the aliphatic carbon chain may form a cyclic moiety. This cyclic moiety can carry the nitrooxy moiety at any position (2, 3, 4), and it can also be branched at multiple positions by any aliphatic groups. The branched aliphatic groups are preferably, methyl, ethyl or propyl. Moreover, the carbon chain may be further substituted with up to 3 hydroxyl-, alkoxy-, amino-, alkylamino-, dialkylamino- or nitrooxy groups.

In the above definition of derivatives of the formula (II) a preferred alkyl group is methyl, ethyl, propyl, isopropyl, butyl, sec. butyl, isobutyl, pentyl, neopentyl, hexyl, cyclohexyl, and 2-ethyl-hexyl and octyl. Furthermore, any alkyl or alkenyl group containing three or more carbon atoms can be straight chain, branched, or cyclic. In addition for the straight chain or branched C2-Cio-alkenylene group, this is understood to encompass alkenylene groups with one or (from C4) more double bonds; examples of such alkenylene groups are those of the formulae —CH═CH—, —CH═CH—CH₂—, —CH═CH—(CH₂)₃— and —(CH═CH)₂—.

In another embodiment, compounds of formula (I) are selected from the list of compounds, and salts thereof as listed with their chemical formula in Table 4.

TABLE 4
Compounds of formula I

| Comp. | | |
|---|---|---|
| Identifier | Molecular structure | Chemical name |
| 1 | 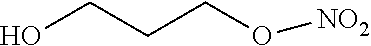 | 3-Nitrooxypropanol |
| 2 | 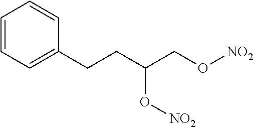 [SMILES: O=[N+]([O-])OCC(CCc1ccccc1)O[N+](=O)[O-]] | rac-4-Phenylbutane-1,2- diyl dinitrate |
| 3 | 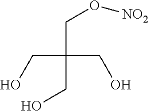 [SMILES: O=[N+]([O-])OCC(CO)(CO)CO] | 2-(Hydroxymethyl)-2- (nitrooxymethyl)-1,3- propanediol |
| 4 | 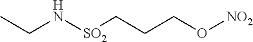 | N-Ethyl-3-nitro-oxy- propionic sulfonyl amide |
| 5 | 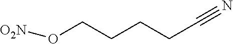 | 5-Nitrooxy-pentanenitrile |
| 6 | 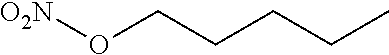 | 5-Nitrooxy-pentane |
| 7 | 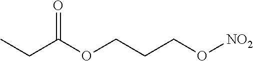 | 3-Nitro-oxy-propyl propionate |
| 8 | 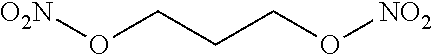 [SMILES: O=[N+]([O-])OCCCO[N+](=O)[O-]] | 1,3-bis-Nitrooxypropane |
| 9 | 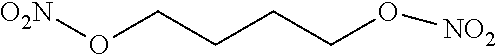 [SMILES: O=[N+]([O-])OCCCCO[N+](=O)[O-]] | 1,4-bis-Nitrooxybutane |
| 10 | 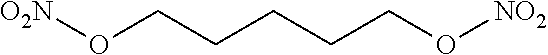 [SMILES: O=[N+]([O-])OCCCCCO[N+](=O)[O-]] | 1,5-bis-Nitrooxypentane |
| 11 | 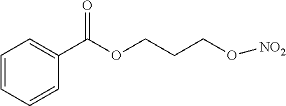 [SMILES: O=C(OCCCO[N+](=O)[O-])c1ccccc1] | 3-Nitro-oxy-propyl benzoate |
| 12 | 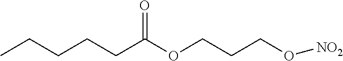 | 3-Nitro-oxy-propyl hexanoate |
| 13 | 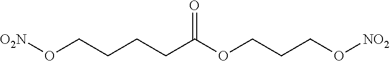 [SMILES: O=C(CCCCO[N+](=O)[O-])OCCCO[N+](=O)[O-]] | 3-Nitro-oxy-propyl 5- nitro-oxy-hexanoate |
| 14 | 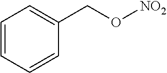 [SMILES: O=[N+]([O-])OCc1ccccc1] | Benzylnitrate |
| 15 | 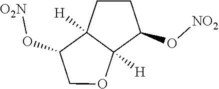 [SMILES: O=[N+]([O-])O[C@H]1CO[C@H]2[C@@H]1CC[C@H]2O[N+](=O)[O-]] | isosorbid-dinitrate |
| 16 | 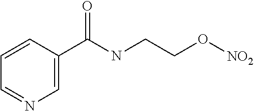 [SMILES: O=C(NCCO[N+](=O)[O-])c1cccnc1] | N-[2-(Nitrooxy)ethyl]-3- pyridinecarboxamide |
| 17 | 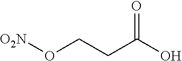 | 3-nitrooxy propionic acid |
| 18 | 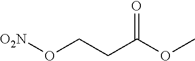 | methyl-3-nitrooxy propionate |
| 19 | 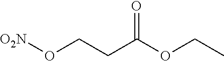 | Ethyl-3-nitrooxy propionate |
| 20 | 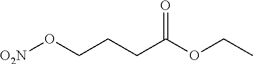 | Ethyl-4-nitrooxy butanoate |
| 21 | 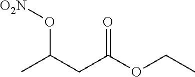 | Ethyl-3-nitrooxy butanoate |
| 22 | 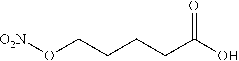 [SMILES: O=C(O)CCCCO[N+](=O)[O-]] | 5-nitrooxy pentanoic acid |
| 23 | 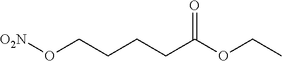 | Ethyl-5-nitrooxy pentanoate |
| 24 | 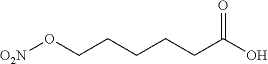 [SMILES: O=C(O)CCCCCO[N+](=O)[O-]] | 6-nitrooxy hexanoic acid |
| 25 | 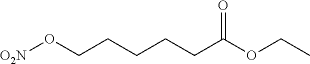 | Ethyl-6-nitrooxy hexanoate |
| 26 | 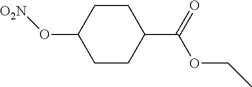 | ethyl-4-nitrooxy- cyclohexylcarboxylate |
| 27 | 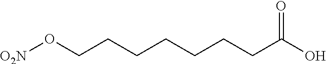 [SMILES: O=C(O)CCCCCCCO[N+](=O)[O-]] | 8-nitrooxy octanoic acid |
| 28 | 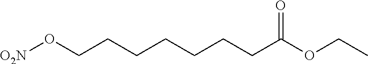 [SMILES: CCOC(=O)CCCCCCCO[N+](=O)[O-]] | Ethyl-8-nitrooxy octanoate |
| 29 | 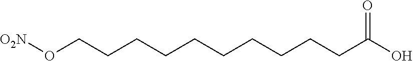 [SMILES: O=C(O)CCCCCCCCCCO[N+](=O)[O-]] | 11-nitrooxy undecanoic acid |
| 30 | 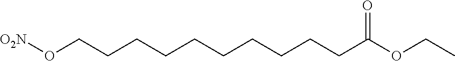 [SMILES: CCOC(=O)CCCCCCCCCCO[N+](=O)[O-]] | Ethyl-11-nitrooxy undecanoate |
| 31 | 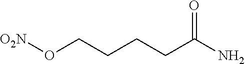 [SMILES: NC(=O)CCCCO[N+](=O)[O-]] | 5-nitrooxy-pentanoic amide |
| 32 | 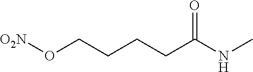 | 5-nitrooxy-N-methyl- pentanoic acid |

In another embodiment, even more preferred compounds of formula (1) are selected from the list of compounds, and salts thereof comprising 3-Nitrooxypropanol, ethyl-3-nitrooxy propionate, methyl-3-nitrooxy propionate, and 3-nitrooxy propionic acid.

The compounds of formula (1) the present invention can also comprise salts of the nitrooxy organic molecule. Preferred cations for salt preparation may be selected from the group consisting of sodium (Na⁺), potassium (K⁺), lithium (Li⁺), magnesium (Mg²⁺), calcium (Ca²⁺), barium (Ba²⁺), strontium (Sr²⁺), and ammonium (NH⁴⁺). Salts may also be prepared from an alkali metal or an alkaline earth metal.

The compounds of formula (I) according to the present invention can be manufactured in principle according to synthetic methods known per se for nitrooxy organic molecules, and/or based on methods as described in PCT/EP2010/069338, and in the European patent application No. 10 195 857.7, incorporated by reference herein.

In all these cases appropriate methods to purify the product (compounds of formula (I)) can be chosen by those skilled in the art, i.e. by column chromatography, or the compound of formula (I), can be isolated and purified by methods known per se, e.g. by adding a solvent such as diethyl-ether or ethyl acetate to induce the separation of the crude product from the mixture after reaction, and drying over Na₂SO₄ of the collected crude product.

### B. Acetogenic Bacteria

An acetogen is a microorganism that generates acetate (CH₃COO⁻) as an end product of anaerobic respiration or fermentation. However, this term is usually employed in a narrower sense only to those bacteria and archaea that perform anaerobic respiration and carbon fixation simultaneously through the reductive acetyl coenzyme A (acetyl-CoA) pathway (also known as the Wood-Ljungdahl pathway). These genuine acetogens are also known as “homoacetogens” and they can produce acetyl-CoA (and from that, in most cases, acetate as the end product) from two molecules of carbon dioxide (CO₂) and four molecules of molecular hydrogen (H₂). This process is known as acetogenesis, and is different from acetate fermentation, although both occur in the absence of molecular oxygen (O₂) and produce acetate. Although previously thought that only bacteria are acetogens, some archaea can be considered to be acetogens.

In some embodiments, the acetogenic bacterial can come from one or more of the following genera: Acetitomaculum, Acetobacterium, Acetohalobium, Acetonema, Alkalibaculum, Blautia, Butyribacterium, Carboxydothermus, Clostridium, Desulfotomaculum, Eubacterium, Fuchsiella, Holophaga, Marvinbryantia, Moorella, Oxobacter, Sporomusa, Terrisporobacter, Terriacetogenum, Thermoanaerobacter, Ruminococcus, and/or Treponema.

In particular, acetogenic bacteria suitable for use in the compositions and methods disclosed herein can be one or more bacteria listed in Table 2 and/or selected from the group consisting of Acetoanaerobium notera (ATCC 35199), Acetonema longum (DSM 6540), Acetobacterium carbinolicum (DSM 2925), Acetobacterium malicum (DSM 4132), Acetobacterium species no. 446 (Morinaga et al., 1990, J. Biotechnol., Vol. 14, p. 187-194), Acetobacterium wieringae (DSM 1911), Acetobacterium woodii (DSM 1030), Alkalibaculum bacchi (DSM 22112), Archaeoglobus fulgidus (DSM 4304), Blautia producta (DSM 2950, formerly Ruminococcus productus, formerly Peptostreptococcus productus), Butyribacterium methylotrophicum (DSM 3468), Clostridium aceticum (DSM 1496), Clostridium autoethanogenum (DSM 10061, DSM 19630 and DSM 23693), Clostridium carboxidivorans (DSM 15243), Clostridium coskatii (ATCC no. PTA-10522), Clostridium drakei (ATCC BA-623), Clostridium formicoaceticum (DSM 92), Clostridium glycolicum (DSM 1288), Clostridium ljungdahlii (DSM 13528), Clostridium ljungdahlii C-01 (ATCC 55988), Clostridium ljungdahlii ERI-2 (ATCC 55380), Clostridium ljungdahlii 0-52 (ATCC 55989), Clostridium mayombei (DSM 6539), Clostridium methoxybenzovorans (DSM 12182), Clostridium neopropionicum sp, Clostridium ragsdalei (DSM 15248), Clostridium scatologenes (DSM 757), Clostridium species ATCC 29797 (Schmidt et al., 1986, Chem. Eng. Commun., Vol. 45, p. 61-73), Desulfotomaculum kuznetsovii (DSM 6115), Desulfotomaculum thermobezoicum subsp. thermosyntrophicum (DSM 14055), Eubacterium limosum (DSM 20543), Methanosarcina acetivorans C2A (DSM 2834), Moorella sp. HUC22-1 (Sakai et al., 2004, Biotechnol. Let., Vol. 29, p. 1607-1612), Moorella thermoacetica (DSM 521, formerly Clostridium thermoaceticum), Moorella thermoautotrophica (DSM 1974), Oxobacter pfennigii (DSM 322), Sporomusa aerivorans (DSM 13326), Sporomusa ovata (DSM 2662), Sporonuisa silvacetica (DSM 10669), Sporomusa sphaeroides (DSM 2875), Sporomusa termitida (DSM 4440) and Thermoanaerobacter kivui (DSM 2030, formerly Acetogenium kivui).

In particular, the acetogenic microbial cell used according to any aspect of the present invention may be selected from the group consisting of Clostridium ljungdahlii and Clostridium autothenogenum. In one example, suitable bacterium may be Clostridium ljungdahlii. In particular, strains selected from the group consisting of Clostridiu ljungdahlii PETC, Clostridium ljungdahlii ERI2, Clostridium ljungdahlii COL and Clostridium ljungdahlii O-52 may be used in the conversion of synthesis gas to hexanoic acid. These strains for example are described in WO 98/00558, WO 00/68407, ATCC 49587, ATCC 55988 and ATCC 55989. In another example, the acetogenic bacteria selected bacteria may be Clostridium autothenogenum.

The expression of the enzyme butyryl-CoA: acetate CoA transferase (cat3) is increased in the cell according to any aspect of the present invention, relative to a wild type cell. This enzyme is especially advantageous in an acetogenic cell according to any aspect of the present invention as it has a broad substrate specificity (Stadtman ER (1953). J Biol Chem 203:501-512 and Stadtman ER (1953) Fed Proc 12:692-693.) and is capable of catalyzing the conversion of acyl CoA to form at least one fatty acid (Seedorf et al., (2007) PNAS. 105 (6): 2128-2133). The production of at least one acid from a carbon source comprising CO and/or CO₂ may be possible in the presence of the acetogenic cell according to any aspect of the present invention due to the presence of the cat3 enzyme. The acid may be produced from the carbon source via acetate production where acetate may be used as the CoA acceptor. This may thus allow the cell according to any aspect of the present invention more efficient and effective in the production of a fatty acid.

In one embodiment, one or more acetogenic bacteria can be included in any of the feed additive formulations disclosed herein and, optionally, may be formulated as a liquid, a dry powder or a granule. In one embodiment, the one or more acetogenic bacteria of any of the feed additive formulations disclosed herein can be formulated as a single mixture. In another embodiment, the one or more acetogenic bacteria of any of the feed additive formulations disclosed herein can be formulated as separate mixtures. In still another embodiment, separate mixtures of one or more acetogenic bacteria of any of the feed additive formulations disclosed herein can be administered at the same time or at different times. In still another embodiment, separate mixtures of one or more acetogenic bacteria of any of the feed additive formulations disclosed herein can be administered simultaneously or sequentially. In yet another embodiment, a first mixture comprising one or more acetogenic bacteria can be administered followed by a second mixture comprising any of the feed additive formulations disclosed herein. In still another embodiment, a first mixture comprising in any of the feed additive formulations disclosed herein can be administered followed by a second mixture comprising one or more acetogenic bacteria.

The dry powder or granules may be prepared by means known to those skilled in the art, such as, in top-spray fluid bed coater, in a bottom spray Wurster or by drum granulation (e.g. High sheer granulation), extrusion, pan coating or in a microingredients mixer.

Acetogenic bacteria may be prepared as culture(s) and carrier(s) (where used) and can be added to a ribbon or paddle mixer and mixed for about 15 minutes, although the timing can be increased or decreased. The components are blended such that a uniform mixture of the cultures and carriers result. The final product can be in one embodiment a dry, flowable powder. In other embodiments, the final product can be encapsulated (particularly when using an anaerobic bacteria as a DFM). The one or more acetogenic bacteria comprising one or more bacterial strains can then be added to animal feed or a feed premix, added to an animal's water, or administered in other ways known in the art. Inclusion of the individual strains in the one or more acetogenic bacteria mixture can be in proportions varying from 1% to 99% and, preferably, from 25% to 75% Suitable dosages of the DFM in animal feed may range from about 1×10³ CFU/g feed to about 1×10¹⁰ CFU/g feed, suitably between about 1×10⁴ CFU/g feed to about 1×10⁸ CFU/g feed, suitably between about 7.5×10⁴ CFU/g feed to about 1×10⁷ CFU/g feed. In another aspect, the DFM may be dosed in feedstuff at more than about 1×10³ CFU/g feed, suitably more than about 1×10⁴ CFU/g feed, suitably more than about 5×10⁴ CFU/g feed, or suitably more than about 1×10⁵ CFU/g feed.

The one or more acetogenic bacteria may be dosed in a feed additive composition from about 1×10³ CFU/g composition to about 1×10¹³ CFU/g composition, such as 1×10⁵ CFU/g composition to about 1×10¹³ CFU/g composition, such as between about 1×10⁶ CFU/g composition to about 1×10¹² CFU/g composition, and such as between about 3.75×10⁷ CFU/g composition to about 1×10¹¹ CFU/g composition. In another aspect, the DFM may be dosed in a feed additive composition at more than about 1×10⁵ CFU/g composition, such as more than about 1×10⁶ CFU/g composition, and such as more than about 3.75×10⁷ CFU/g composition. In one embodiment, the one or more acetogenic bacteria is dosed in the feed additive composition at more than about 2×10⁵ CFU/g composition, such as more than about 2×10⁶ CFU/g composition, suitably more than about 3.75×10⁷ CFU/g composition.

C. Compounds that Promote Hydrogen Consumption in the Rumen

In further aspects, any of the feed additive or feed compositions disclosed herein can further include one or more compounds that promote hydrogen consumption (i.e. consumption of reducing power) in the rumen. These compounds can include, without limitation, nitrates, sulfates, nitrocompounds (e.g., 3-nitropropionate, 2-nitropropanol, 2-nitroethanol, and/or nitroethane), and/or propionate precursors (e.g. malate, acrylate, oxaloacetate, and/or fumarate).

In some embodiments, the one or more compounds that promote hydrogen consumption in the rumen are administered to the ruminant animal at concentrations of any of 1 mg/kg body weight (bw), 1.1 mg/kg, 1.2 mg/kg, 1.3 mg/kg, 1.4 mg/kg, 1.5 mg/kg, 1.6 mg/kg, 1.7 mg/kg, 1.8 mg/kg, 1.9 mg/kg, 2 mg/kg, 2.1 mg/kg, 2.2 mg/kg, 2.3 mg/kg, 2.4 mg/kg, 2.5 mg/kg, 2.6 mg/kg, 2.7 mg/kg, 2.8 mg/kg, 2.9 mg/kg, 3 mg/kg, 3.1 mg/kg, 3.2 mg/kg, 3.3 mg/kg, 3.4 mg/kg, 3.5 mg/kg, 3.6 mg/kg, 3.7 mg/kg, 3.8 mg/kg, 3.9 mg/kg, 4 mg/kg, 4.1 mg/kg, 4.2 mg/kg, 4.3 mg/kg, 4.4 mg/kg, 4.5 mg/kg, 4.6 mg/kg, 4.7 mg/kg, 4.8 mg/kg, 4.9 mg/kg, 5 mg/kg, 5.1 mg/kg, 5.2 mg/kg, 5.3 mg/kg, 5.4 mg/kg, 5.5 mg/kg, 5.6 mg/kg, 5.7 mg/kg, 5.8 mg/kg, 5.9 mg/kg, 6 mg/kg, 6.1 mg/kg, 6.2 mg/kg, 6.3 mg/kg, 6.4 mg/kg, 6.5 mg/kg, 6.6 mg/kg, 6.7 mg/kg, 6.8 mg/kg, 6.9 mg/kg, 7 mg/kg, or more.

### D. Essential Oils

In one embodiment, the disclosure includes ruminant feed additive or feed compositions comprising (a) one or more rumen inhibitor compounds; and (b) (1) one or more acetogenic bacteria; and/or (2) one or more compounds that promote hydrogen consumption in the rumen and further containing at least one essential oil (e.g. cinnamaldehyde and/or thymol). Essential oils are concentrated volatile oils having the characteristic odor of the plant from which they are derived. Typically, essential oils are obtained by distillation of the plant and comprise a mixture of component compounds. These component compounds of essential oils include anethole, beta-ionone, capsaicin, carvacrol, cinnamaldehyde, citral, cresols, eugenol, guaiacol, limonene, thymol, tannin and vanillin.

The animal feed or feed additive compositions disclosed herein may comprise at least 1 g of cinnamaldehyde per 1000 kg of animal feed, at least 2 g of cinnamaldehyde per 1000 kg of animal feed, at least 3 g of cinnamaldehyde per 1000 kg of animal feed, at least 4 g of cinnamaldehyde per 1000 kg of animal feed, at least 5 g of cinnamaldehyde per 1000 kg of animal feed.

The animal feed or feed additive compositions disclosed herein may comprise at least 1 mg of cinnamaldehyde per kg of animal feed, at least 2 mg of cinnamaldehyde per kg of animal feed, at least 3 mg of cinnamaldehyde per kg of animal feed, at least 4 mg of cinnamaldehyde per kg of animal feed, at least 5 mg of cinnamaldehyde per kg of animal feed.

The animal feed or feed additive compositions disclosed herein may comprise less than 6 g of cinnamaldehyde per 1000 kg of the animal feed; such as, e.g., less than 5.9 g of cinnamaldehyde. The animal feed may comprise less than 18 g of cinnamaldehyde per 1000 kg of animal feed, such as, e.g. less than 17 g of cinnamaldehyde per 1000 kg of animal feed, less than 16 g of cinnamaldehyde per 1000 kg of animal feed, less than 15 g of cinnamaldehyde per 1000 kg of animal feed, less than 14 g of cinnamaldehyde per 1000 kg of animal feed.

Where the animal feed or feed additive compositions disclosed herein includes thymol, the animal feed may comprise at least 1 g of thymol per 1000 kg of animal feed or feed additive compositions, at least 2 g of thymol per 1000 kg of animal feed or feed additive compositions, at least 3 g of thymol per 1000 kg of animal feed or feed additive compositions, at least 4 g of thymol per 1000 kg of animal feed or feed additive compositions, at least 5 g of thymol per 1000 kg of animal feed or feed additive compositions, at least 6 g of thymol per 1000 kg of animal feed or feed additive compositions, at least 7 g of thymol per 1000 kg of animal feed or feed additive compositions, at least 8 g of thymol per 1000 kg of animal feed or feed additive compositions, at least 9 g of thymol per 1000 kg of animal feed or feed additive compositions, at least 10 g of thymol per 1000 kg of animal feed or feed additive compositions, at least 11 g of thymol per 1000 kg of animal feed or feed additive compositions, at least 12 g of thymol per 1000 kg of animal feed or feed additive compositions, at least 13 g of thymol per 1000 kg of animal feed or feed additive compositions, at least 14 g of thymol per 1000 kg of animal feed or feed additive compositions, at least 15 g of thymol per 1000 kg of animal feed or feed additive compositions. The animal feed or feed additive compositions may comprise less than 50 g of thymol per 1000 kg of animal feed or feed additive compositions.

### E. Enzymes

In one embodiment, the disclosure includes ruminant feed additive or feed compositions comprising (a) one or more rumen inhibitor compounds; and (b) (1) one or more acetogenic bacteria; and/or (2) one or more compounds that promote hydrogen consumption in the rumen and further containing at least one enzyme (e.g. a glucoamylase and/or a phytase). Suitable enzymes for use in accordance with the methods disclosed herein include, without limitation, glucoamylases, xylanases, amylases, phytases, fucosidases, beta-glucanases, and proteases.

### 1. Glucoamylases

Glucoamylase (1,4-alpha-D-glucan glucohydrolase, EC 3.2.1.3) is an enzyme, which catalyzes the release of D-glucose from the non-reducing ends of starch or related oligo- and poly-saccharide molecules. Glucoamylases are produced by several filamentous fungi and yeast.

In one embodiment, the disclosure includes ruminant feed additive or feed compositions comprising (a) one or more rumen inhibitor compounds; and (b) (1) one or more acetogenic bacteria; and/or (2) one or more compounds that promote hydrogen consumption in the rumen and further including one or more glucoamylase. The glucoamylase may be any commercially available glucoamylase. Suitably the glucoamylase may be an 1,4-alpha-D-glucan glucohydrolase (EC 3.2.1.3). The glucoamylase enzyme may be encapsulated, coated to prevent or limit degradation in the rumen environment, or otherwise in the form of a granule. All E.C. enzyme classifications referred to herein relate to the classifications provided in Enzyme Nomenclature—Recommendations (1992) of the nomenclature committee of the International Union of Biochemistry and Molecular Biology—ISBN 0-12-226164-3, which is incorporated herein.

Glucoamylases have been used successfully in commercial applications for many years. Additionally, various mutations have been introduced in fungal glucoamylases, for example, Trichoderma reesei glucoamylase (TrGA), to enhance thermal stability and specific activity. See, e.g., WO 2008/045489; WO 2009/048487; WO 2009/048488; and U.S. Pat. No. 8,058,033. Glucoamylase activity can be assessed using any means known in the art, including those described in the Examples section, infra.

A glucoamylase may be derived from any suitable source, e.g., derived from a microorganism or a plant. Glucoamylases can be from fungal or bacterial origin, selected from the group consisting of Aspergillus glucoamylases, in for example, Aspergillus niger G1 or G2 glucoamylase (Boel et al., 1984, EMBO J. 3 (5): 1097-1102), or variants thereof, such as those disclosed in WO 92/00381, WO 00/04136 and WO 01/04273 (from Novozymes, Denmark); the A. awamori glucoamylase disclosed in WO 84/02921, Aspergillus oryzae glucoamylase (Hata et al., 1991, Agric. Biol. Chem. 55 (4): 941-949), or variants or fragments thereof. Other Aspergillus glucoamylase variants include variants with enhanced thermal stability: G137A and G139A (Chen et al., 1996, Prot. Eng. 9:499-505); D257E and D293E/Q (Chen et al., 1995, Prot. Eng. 8:575-582); N182 (Chen et al., 1994, Biochem. J. 301:275-281); disulphide bonds, A246C (Fierobe et al., 1996, Biochemistry 35:8698-8704; and introduction of Pro residues in positions A435 and S436 (Li et al., 1997, Protein Eng. 10:1199-1204.

Other glucoamylases include Athelia rolfsii (previously denoted Corticium rolfsi) glucoamylase (see U.S. Pat. No. 4,727,026 and Nagasaka et al., 1998, Appl. Microbiol. Biotechnol. 50:323-330), Talaromyces glucoamylases, in particular derived from Talaromyces duponti, Talaromyces emersonii (WO 99/28448), Talaromyces leycettanus (U.S. Pat. No. Re. 32,153), and Talaromyces thermophilus (U.S. Pat. No. 4,587,215).

Bacterial glucoamylases include glucoamylases from Clostridium, in particular C. thermoamylolyticum (EP 135138) and C. thermohydrosulfuricum (WO86/01831), Trametes cingulata, Pachykytospora papyracea, and Leucopaxillus giganteus, all disclosed in WO 2006/069289; or Peniophora rufomarginata disclosed in WO2007/124285 or PCT/US2007/066618; or a mixture thereof. A hybrid glucoamylase may be used in the present invention. Examples of hybrid glucoamylases are disclosed in WO 2005/045018. Specific examples include the hybrid glucoamylase disclosed in Tables 1 and 4 of Example 1 (which hybrids are hereby incorporated by reference).

The glucoamylase may have a high degree of sequence identity to any of above mentioned glucoamylases, i.e., at least 70%, at least 75%, at least 80%, at least 85%, at least 90%, at least 95%, at least 96%, at least 97%, at least 98%, at least 99% or even 100% identity to the mature enzymes sequences mentioned above.

Commercially available glucoamylase compositions include AMG 200L; AMG 300L; SAN™ SUPER, SAN™ EXTRA L, SPIRIZYME™ PLUS, SPIRIZYME™ FUEL, SPIRIZYME™ B4U, SPIRIZYME ULTRA, SPIRIZYME™ EXCEL and AMG™ E (from Novozymes A/S, Denmark); OPTIDEX™ 300, GC480™ and GC147™ (from Genencor Int., USA); AMIGASE™ and AMIGASE™ PLUS (from DSM); G-ZYME™ G900, G-ZYME™ and G990 ZR (from Genencor Int.).

### 2. Phytases

In another embodiment, the disclosure includes ruminant feed additive or feed compositions comprising (a) one or more rumen inhibitor compounds; and (b) (1) one or more acetogenic bacteria; and/or (2) one or more compounds that promote hydrogen consumption in the rumen and further including one or more phytase. The phytase for use in the present invention may be classified a 6-phytase (classified as E.C. 3.1.3.26) or a 3-phytase (classified as E.C. 3.1.3.8). The phytase enzyme may be encapsulated, coated to prevent or limit degradation in the rumen environment, or otherwise in the form of a granule. In one embodiment, the phytase for use in the present invention may be one or more of the phytases in one or more of the commercial products below in Table 5:

TABLE 5
Representative commercial phytases

| Commercial | | Phytase | |
|---|---|---|---|
| Product ® | Company | type | Phytase source |
| Finase | ABVista | 3-Phytase | Trichoderma ressei |
| Finase EC | ABVista | 6-Phytase | E. coli gene expressed |
| | | | in Trichoderma ressei |
| Natuphos | BASF | 3-Phytase | Aspergillus Niger |
| Natazyme | Bioproton | Phytase | Trichoderma |
| | | (type not | longibrachiatum/ |
| | | specified) | Trichoderma ressei |
| OPTIPHOS ® | Huvepharma | 6-Phytase | E. coli gene expressed |
| | AD | | in pichia pastoris |
| Phytase | DSM | 3-Phytase | A consensus gene expressed |
| sp1002 | | | in hansenuia polymorpha |
| Phyzyme XP | Danisco | 6-Phytase | E. coli gene expressed in |
| | | | schizosaccahomyces pombe |
| Quantum | ABVista | 6-Phytase | E. coli gene expressed |
| 2500D, | | | in Pichia pastoris or |
| 5000L | | | Trichoderma |
| Ronozyme | DSM/ | 6-Phytase | Citrobacter braakii |
| Hi-Phos | Novozymes | | gene expressed in |
| (ML) | | | Aspergillus oryzae |
| Ronozyme NP | DSM/ | 6-Phytase | Peniphora lycii gene |
| | Novozymes | | expressed in |
| | | | Aspergillus oryzae |
| Ronozyme P | DSM/ | 6-Phytase | Peniphora lycii gene |
| | Novozymes | | expressed in |
| | | | Aspergillus oryzae |
| Rovabio | Adisseo | 3-Phytase | Penicillium funiculosum |
| PHY | | | |

In one embodiment the phytase is a Citrobacter phytase derived from e.g. Citrobacter freundii, In some embodiments, C. freundii NCIMB 41247 and variants thereof e.g. as disclosed in WO2006/038062 (incorporated herein by reference) and WO2006/038128 (incorporated herein by reference), Citrobacter braakii YH-15 as disclosed in WO 2004/085638, Citrobacter braakii ATCC 51113 as disclosed in WO2006/037328 (incorporated herein by reference), as well as variants thereof e.g. as disclosed in WO2007/112739 (incorporated herein by reference) and WO2011/117396 (incorporated herein by reference), Citrobacter amalonaticus, In some embodiments, Citrobacter amalonaticus ATCC 25405 or Citrobacter amalonaticus ATCC 25407 as disclosed in WO2006037327 (incorporated herein by reference), Citrobacter gillenii, In some embodiments, Citrobacter gillenii DSM 13694 as disclosed in WO2006037327 (incorporated herein by reference), or Citrobacter intermedius, Citrobacter koseri, Citrobacter murliniae, Citrobacter rodentium, Citrobacter sedlakii, Citrobacter werkmanii, Citrobacter youngae, Citrobacter species polypeptides or variants thereof.

In some embodiments, the phytase is an E. coli phytase marketed under the name Phyzyme XP™ Danisco A/S. Alternatively, the phytase may be a Buttiauxella phytase, e.g. a Buttiauxella agrestis phytase, for example, the phytase enzymes taught in WO 2006/043178, WO 2008/097619, WO2009/129489, WO2008/092901, PCT/US2009/41011 or PCT/IB2010/051804, all of which are incorporated herein by reference. Alternatively, the phytase can be an engineered, robust high Tm clade phytase polypeptide, for example, a phytase disclosed in WO2020/106796, incorporated by reference herein.

In one embodiment, the phytase may be a phytase from Hafnia, e.g. from Hafnia alvei, such as the phytase enzyme(s) taught in US2008263688, which reference is incorporated herein by reference. In one embodiment, the phytase may be a phytase from Aspergillus, e.g. from Apergillus orzyae. In one embodiment, the phytase may be a phytase from Penicillium, e.g. from Penicillium funiculosum.

In some embodiments, the phytase is present in the feed or feed-additive compositions in range of about 1000 FTU/kg to about 8000 FTU/kg feed. In some embodiments, about 2000 FTU/kg feed to about 7000 FTU/kg feed. In some embodiments, about 3000 FTU/kg feed to about 6000 FTU/kg feed. In one embodiment, the phytase is present in the feedstuff at more than about 200 FTU/kg feed, suitably more than about 300 FTU/kg feed, suitably more than about 400 FTU/kg feed. In one embodiment, the phytase is present in the feedstuff at less than about 1000 FTU/kg feed, suitably less than about 750 FTU/kg feed. In some embodiments, the phytase is present in the feed additive composition in range of about 40 FTU/g to about 40,000 FTU/g composition; about 80 FTU/g composition to about 20,000 FTU/g composition; about 100 FTU/g composition to about 10,000 FTU/g composition; and about 200 FTU/g composition to about 10,000 FTU/g composition. In one embodiment, the phytase is present in the feed additive composition at more than about 40 FTU/g composition, suitably more than about 60 FTU/g composition, suitably more than about 100 FTU/g composition, suitably more than about 150 FTU/g composition, suitably more than about 200 FTU/g composition. In one embodiment, the phytase is present in the feed additive composition at less than about 40,000 FTU/g composition, suitably less than about 20,000 FTU/g composition, suitably less than about 15,000 FTU/g composition, suitably less than about 10,000 FTU/g composition.

It will be understood that as used herein 1 FTU (phytase unit) is defined as the amount of enzyme required to release 1 μmol of inorganic orthophosphate from a substrate in one minute under the reaction conditions defined in the ISO 2009 phytase assay-A standard assay for determining phytase activity and 1 FTU can be found at International Standard ISO/DIS 30024:1-17, 2009. In one embodiment, the enzyme is classified using the E.C. classification above, and the E.C. classification designates an enzyme having that activity when tested in the assay taught herein for determining 1 FTU.

### F. Feed and Feed Additive Formulations

Animal feeds may include plant material such as corn, wheat, sorghum, soybean, canola, sunflower or mixtures of any of these plant materials or plant protein sources for poultry, pigs, ruminants, aquaculture and pets. The terms “animal feed,” “feedstuff” and “forage” are used interchangeably and can comprise one or more feed materials selected from the group comprising a) forages, such as pasture, grass, hay, alfalfa, grass silage, corn silage; b) cereals, such as small grains (e.g., wheat, barley, rye, oats and combinations thereof) and/or large grains such as maize or sorghum; c) by products from cereals, such as corn gluten meal, Distillers Dried Grains with Solubles (DDGS) (particularly corn based Distillers Dried Grains with Solubles (cDDGS), wheat bran, wheat middlings, wheat shorts, rice bran, rice hulls, oat hulls, palm kernel, and citrus pulp; d) protein obtained from sources such as soya, sunflower, peanut, lupin, peas, fava beans, cotton, canola, fish meal, dried plasma protein, meat and bone meal, potato protein, whey, copra, sesame; e) oils and fats obtained from vegetable and animal sources; and/or f) minerals and vitamins.

When used as, or in the preparation of, a feed, such as functional feed, the feed or feed additive composition of the present invention may be used in conjunction with one or more of: a nutritionally acceptable carrier, a nutritionally acceptable diluent, a nutritionally acceptable excipient, a nutritionally acceptable adjuvant, a nutritionally active ingredient. For example, there could be mentioned at least one component selected from the group consisting of a protein, a peptide, sucrose, lactose, sorbitol, glycerol, propylene glycol, sodium chloride, sodium sulfate, sodium acetate, sodium citrate, sodium formate, sodium sorbate, potassium chloride, potassium sulfate, potassium acetate, potassium citrate, potassium formate, potassium acetate, potassium sorbate, magnesium chloride, magnesium sulfate, magnesium acetate, magnesium citrate, magnesium formate, magnesium sorbate, sodium metabisulfite, methyl paraben and propyl paraben.

In one embodiment the feed or feed additive composition of the present invention is admixed with a feed component to form a feedstuff. The term “feed component” as used herein means all or part of the feedstuff. Part of the feedstuff may mean one constituent of the feedstuff or more than one constituent of the feedstuff, e.g. 2 or 3 or 4 or more. In one embodiment the term “feed component” encompasses a premix or premix constituents.

In some embodiments, the feed may be a forage, or a premix thereof, a compound feed, or a premix thereof. A feed additive composition according to the present invention may be admixed with a compound feed, a compound feed component or to a premix of a compound feed or to a forage, a forage component, or a premix of a forage.

The term “forage” as used herein means any food which is provided to or grazed by an animal. Furthermore, forage includes silage, compressed and pelleted feeds, oils and mixed rations, and also sprouted grains and legumes.

Forage may be obtained from one or more of the plants selected from: Gramineae, corn (maize), alfalfa (Lucerne), barley, birdsfoot trefoil, brassicas, Chau moellier, kale, rapeseed (canola), rutabaga (swede), turnip, clover, alsike clover, red clover, subterranean clover, white clover, fescue, brome, millet, oats, sorghum, soybeans, trees (pollard tree shoots for tree-hay), wheat, and legumes.

The term “compound feed” means a commercial feed in the form of a meal, a pellet, nuts, cake or a crumble. Compound feeds may be blended from various raw materials and additives.

These blends are formulated according to the specific requirements of the target animal.

Compound feeds can be complete feeds that provide all the daily required nutrients, concentrates that provide a part of the ration (protein, energy) or supplements that only provide additional nutrients, such as minerals and vitamins. The main ingredients used in compound feed are the feed grains, which include corn, wheat, canola meal, rapeseed meal, lupin, soybeans, sorghum, oats, and barley.

Suitably a “premix” as referred to herein may be a composition composed of microingredients such as vitamins, minerals, chemical preservatives, antibiotics, fermentation products, and other essential ingredients. Premixes are usually compositions suitable for blending into commercial rations.

In another aspect, when the feed additive composition is formulated into granules the granules comprise a hydrated barrier salt coated over a protein core. The advantage of such salt coating is improved thermo-tolerance, improved storage stability and protection against other feed additives otherwise having adverse effect on the feed additive. Preferably, the salt used for the salt coating has a water activity greater than 0.25 or constant humidity greater than 60% at 20 C. In some embodiments, the salt coating comprises Na₂SO₄.

It will be understood by the skilled person that different animals require different feedstuffs, and even the same animal may require different feedstuffs, depending upon the purpose for which the animal is reared. Optionally, the feedstuff may also contain additional minerals such as, for example, calcium and/or additional vitamins. In some embodiments, the feedstuff is a corn soybean meal, wheat, or mixed grain mix.

Feedstuff is typically produced in feed mills in which raw materials are first ground to a suitable particle size and then mixed with appropriate additives. The feedstuff may then be produced as a mash or pellets; the later typically involves a method by which the temperature is raised to a target level and then the feed is passed through a die to produce pellets of a particular size. The pellets are allowed to cool. Subsequently liquid additives such as fat and enzyme may be added. Production of feedstuff may also involve an additional step that includes extrusion or expansion prior to pelleting, in particular by suitable techniques that may include at least the use of steam.

The feed additive composition and/or the feedstuff comprising the same may be used in any suitable form. The feed additive composition may be used in the form of solid or liquid preparations or alternatives thereof Examples of solid preparations include powders, pastes, boluses, capsules, pellets, tablets, dusts, and granules which may be wettable, spray-dried or freeze-dried. Examples of liquid preparations include, but are not limited to, aqueous, organic or aqueous-organic solutions, suspensions and emulsions.

In some applications, the feed additive compositions may be mixed with feed or administered in the drinking water (for example, drinking water derived from water wells, fountains, shallow wells, semi-artesian and artesian wells, municipal water supplies, lakes or creeks). In other embodiments, one or more components of the feed additive composition (e.g. (a) one or more rumen inhibitor compounds; and (b) (1) one or more acetogenic bacteria; and/or (2) one or more compounds that promote hydrogen consumption in the rumen) is administered in the drinking water and one or more components of the feed additive composition is administered in the feed concurrently or simultaneously. When water line delivery is contemplated, administration of the feed additive composition can include, without limitation, one or more of mixing the composition into water, rehydrating the composition components (e.g., the acetogenic bacteria), adding hydrated composition to a medicator and administering it into a water line via a dosatron or other pumping means.

The feedstuff and/or feed additive composition may be combined with at least one mineral and/or at least one vitamin. The compositions thus derived may be referred to herein as a premix. The feedstuff may comprise at least 0.0001% by weight of the feed additive. Suitably, the feedstuff may comprise at least 0.0005%; at least 0.0010%; at least 0.0020%; at least 0.0025%; at least 0.0050%; at least 0.0100%; at least 0.020%; at least 0.100% at least 0.200%; at least 0.250%; at least 0.500% by weight of the feed additive.

Preferably, a food or feed additive composition may further comprise at least one physiologically acceptable carrier. The physiologically acceptable carrier is preferably selected from at least one of maltodextrin, limestone (calcium carbonate), cyclodextrin, wheat or a wheat component, sucrose, starch, Na2S04, Talc, PVA and mixtures thereof. In a further embodiment, the food or feed additive may further comprise a metal ion chelator. The metal ion chelator may be selected from EDTA or citric acid.

Formulations comprising any enzyme as described herein may be made in any suitable way to ensure that the formulation comprises active enzymes. Such formulations may be as a liquid, a dry powder or a granule. Preferably, the feed additive composition is in a solid form suitable for adding on or to a feed pellet.

Dry powder or granules may be prepared by means known to those skilled in the art, such as, high shear granulation, drum granulation, extrusion, spheronization, fluidized bed agglomeration, fluidized bed spray drying.

Feed additive composition described herein can be formulated to a dry powder or granules as described in WO2007/044968 (referred to as TPT granules) or WO1997/016076 or WO1992/012645 (each of which is incorporated herein by reference).

In one embodiment animal feed may be formulated to a granule for feed compositions comprising: a core; an active agent; and at least one coating, the active agent of the granule retaining at least 50% activity, at least 60% activity, at least 70% activity, at least 80% activity after conditions selected from one or more of a) a feed pelleting process, b) a steam-heated feed pretreatment process, c) storage, d) storage as an ingredient in an unpelleted mixture, and e) storage as an ingredient in a feed base mix or a feed premix comprising at least one compound selected from trace minerals, organic acids, reducing sugars, vitamins, choline chloride, and compounds which result in an acidic or a basic feed base mix or feed premix.

With regard to the granule at least one coating may comprise a moisture hydrating material that constitutes at least 55% w/w of the granule; and/or at least one coating may comprise two coatings. The two coatings may be a moisture hydrating coating and a moisture barrier coating. In some embodiments, the moisture hydrating coating may be between 25% and 60% w/w of the granule and the moisture barrier coating may be between 2% and 15% w/w of the granule. The moisture hydrating coating may be selected from inorganic salts, sucrose, starch, and maltodextrin and the moisture barrier coating may be selected from polymers, gums, whey and starch.

The feed additive composition may be formulated to a granule for animal feed comprising: a core; an active agent, the active agent of the granule retaining at least 80% activity after storage and after a steam-heated pelleting process where the granule is an ingredient; a moisture barrier coating; and a moisture hydrating coating that is at least 25% w/w of the granule, the granule having a water activity of less than 0.5 prior to the steam-heated pelleting process.

### III. Methods

### A. Methods for Reducing Methane Production and Improving Animal Performance

The present disclosure relates to a method for reducing the production of methane emanating from the digestive activities of ruminants and/or for improving ruminant animal performance comprising orally administering to the animal an effective amount of any of the feed additive or feed compositions disclosed herein.

In some embodiments, administering an effective amount of a ruminant feed or feed additive composition containing one or more rumen inhibitor compounds, and one or more acetogenic bacteria and/or one or more compounds that promote hydrogen consumption in the rumen to a ruminant results in decreased methane production (such as a decrease by any of about 1%, 2%, 3%, 4%, 5%, 10%, 15%, 20%, 25%, 30%, 35%, 40%, 45%, 50%, 55%, 60%, 65%, 70%, 75%, 80%, 85%, 90%, 95%, or 100% decreased production inclusive of all values in between these percentages) compared to the amount of methane produced in a ruminant that has not been administered an effective amount of a feed or feed additive composition disclosed herein.

In other embodiments, administering an effective amount of a ruminant feed or feed additive composition containing one or more rumen inhibitor compounds, and one or more acetogenic bacteria and/or one or more compounds that promote hydrogen consumption in the rumen to a ruminant results in increased ruminal acetate production (such as an increase by any of about 1%, 2%, 3%, 4%, 5%, 10%, 15%, 20%, 25%, 30%, 35%, 40%, 45%, 50%, 55%, 60%, 65%, 70%, 75%, 80%, 85%, 90%, 95%, 100%, 105%, 110%, 115%, 120% or 125% or more increased production, inclusive of all values in between these percentages) compared to ruminal acetate production in a ruminant that has not been administered an effective amount of a feed or feed additive composition disclosed herein, or has only been administered one or more rumen inhibitor compounds.

In some embodiments, administering an effective amount of a ruminant feed or feed additive composition containing one or more rumen inhibitor compounds, and one or more acetogenic bacteria and/or one or more compounds that promote hydrogen consumption in the rumen to a ruminant results in decreased feed conversion ratio (FCR; such as a decrease by any of about 1%, 2%, 3%, 4%, 5%, 10%, 15%, 20%, 25%, 30%, 35%, 40%, 45%, 50%, 55%, 60%, 65%, 70%, 75%, 80%, 85%, 90%, 95%, or 100% decreased FCR inclusive of all values in between these percentages) compared to the FCR of a ruminant that has not been administered an effective amount of a feed or feed additive composition disclosed herein, or has only been administered one or more rumen inhibitor compounds.

In other embodiments, administering an effective amount of a ruminant feed or feed additive composition containing one or more rumen inhibitor compounds, and one or more acetogenic bacteria and/or one or more compounds that promote hydrogen consumption in the rumen to a ruminant results in increased feed intake (such as an increase by any of about 1%, 2%, 3%, 4%, 5%, 10%, 15%, 20%, 25%, 30%, 35%, 40%, 45%, 50%, 55%, 60%, 65%, 70%, 75%, 80%, 85%, 90%, 95%, 100%, 105%, 110%, 115%, 120% or 125% or more increased feed intake, inclusive of all values in between these percentages) compared to the feed intake of a ruminant that has not been administered an effective amount of a feed or feed additive composition disclosed herein, or has only been administered one or more rumen inhibitor compounds.

In other embodiments, administering an effective amount of a ruminant feed or feed additive composition containing one or more rumen inhibitor compounds, and one or more acetogenic bacteria and/or one or more compounds that promote hydrogen consumption in the rumen to a ruminant results in increased weight gain (such as an increase by any of about 1%, 2%, 3%, 4%, 5%, 10%, 15%, 20%, 25%, 30%, 35%, 40%, 45%, 50%, 55%, 60%, 65%, 70%, 75%, 80%, 85%, 90%, 95%, 100%, 105%, 110%, 115%, 120% or 125% or more increased weight gain, inclusive of all values in between these percentages) compared to the weight gain of a ruminant that has not been administered an effective amount of a feed or feed additive composition disclosed herein, or has only been administered one or more rumen inhibitor compounds.

In other embodiments, administering an effective amount of a ruminant feed or feed additive composition containing one or more rumen inhibitor compounds, and one or more acetogenic bacteria and/or one or more compounds that promote hydrogen consumption in the rumen to a ruminant results in increased carcass yield (such as an increase by any of about 1%, 2%, 3%, 4%, 5%, 10%, 15%, 20%, 25%, 30%, 35%, 40%, 45%, 50%, 55%, 60%, 65%, 70%, 75%, 80%, 85%, 90%, 95%, 100%, 105%, 110%, 115%, 120% or 125% or more increased carcass yield, inclusive of all values in between these percentages) compared to the carcass yield of a ruminant that has not been administered an effective amount of a feed or feed additive composition disclosed herein, or has only been administered one or more rumen inhibitor compounds.

In other embodiments, administering an effective amount of a ruminant feed or feed additive composition containing one or more rumen inhibitor compounds, and one or more acetogenic bacteria and/or one or more compounds that promote hydrogen consumption in the rumen to a ruminant results in increased milk, or milk fat content and/or yield, or milk protein content and/or yield (such as an increase by any of about 1%, 2%, 3%, 4%, 5%, 10%, 15%, 20%, 25%, 30%, 35%, 40%, 45%, 50%, 55%, 60%, 65%, 70%, 75%, 80%, 85%, 90%, 95%, 100%, 105%, 110%, 115%, 120% or 125% or more increased milk, or milk fat content and/or yield, or milk protein content and/or yield, inclusive of all values in between these percentages) compared to the milk, or milk fat content and/or yield, or milk protein content and/or yield of a ruminant that has not been administered an effective amount of a feed or feed additive composition disclosed herein, or has only been administered one or more rumen inhibitor compounds.

### B. Methods for Producing a Feed Additive or Feed Composition

Also provided herein are methods for producing a feed additive or feed composition comprising combining one or more rumen inhibitor compounds (such as any of the rumen inhibitor compounds disclosed herein; and one or more acetogenic bacteria (such as any of the acetogenic bacteria disclosed herein); and/or one or compounds that promote hydrogen consumption in the rumen (such as any of those disclosed herein). In additional embodiments, the method also includes packaging the feed additive or feed composition.

The invention can be further understood by reference to the following examples, which are provided by way of illustration and are not meant to be limiting.

### Examples

### Example 1: Use of a Composition that Causes Ruminal Hydrogen Production in Combination with an Acetogenic Bacteria in Ruminant Feed to Decrease Methane and Increase VFA Production

The example describes the specific combination of rumen inhibitors with Acetitomaculum ruminis DSM 5522, Acetobacterium woodii DSM 1030, acetogenic bacteria sourced from DSMZ German culture collection. Several treatments are tested in separate fermentation vials.

Without being bound to theory, it is believed that the combined addition of one or more rumen inhibitor compound that causes H₂ buildup in the rumen with one or more acetogenic bacteria will result in the dual benefit of decreased ruminant production of methane and increased production of total volatile fatty acids (VFA, e.g., short chain fatty acids-end products of rumen fermentation, mostly acetic, propionic, butyric, iso-butyric, valeric, and iso-valeric acids). This dual benefit is only achieved by the combination of the ruminant inhibitor compound and acetogenic bacteria.

### Experimental Design:

Control: no additives added to feed
Part 1: A rumen inhibitor compound that causes H₂ buildup in the rumen, e.g. a compound selected from Table 1 or any rumen inhibitor compound disclosed herein. Several addition levels are tested in the range of 0.0 to 0.5 mg per g dry matter (DM) substrate
Part 2: One or more acetogen species is added in a range of 0 to 10⁹ CFU/ml
Part 1+part 2: both rumen inhibitor and acetogenic bacteria are added, each of them in the same range specified above.

TABLE 1
Non-limiting Examples of ruminant inhibitor
compounds that cause H₂ buildup in the rumen

| Category | Subcategory | Examples |
|---|---|---|
| Nitrooxy compounds | — | 3-nitrooxypropanol |
| | | Ethyl-3-nitrooxypropanol |
| Coenzyme M (2- | Halogenated | 2-bromoethanosulfonate |
| mercaptoethane- | sulfonated | 2-chloroethanesulfonate |
| sulfonic acid) | compounds | 2-chloroethanesulfonate |
| analogs | | 3-bromopropanesulfonate |
| | Halogenated | Chloroform |
| | aliphatic | Bromochloromethane |
| | compounds | Bromoform |
| | | Bromodichloromethane |
| | | Dibromochloromethane |
| | | Carbon tetrachloride |
| | | Trichloroacetamide |
| | | Trichloroethyladipate |
| | Natural sources | Asparagopsis taxiformis |
| Pterin compounds | — | 2,4-pteridinedione |
| Hydroxymethyl- | Statins | Lovastatin |
| glutaryl- | | Mevastatin |
| CoA reductase | Natural sources | Monascus purpureus |
| inhibitors | of statins | Pleurotus ostreatus |
| | | Aspergillus terreus |
| | | Penicillium spp. |
| | Diallyl disulfide | Garlic |
| | and natural | |
| | sources of this | |
| Antimicrobial | — | Nisin |
| peptides | | (Nisaplin ®_Danisco) |
| Plant secondary | Tannins | |
| metabolites | Flavonoids | |
| | Saponins | |
| | Essential oils | |

TABLE 2
Non-limiting examples of acetogenic bacteria

| Category | Examples |
|---|---|
| Acetogenic | Acetobacterium bakii DSM 8239 |
| bacteria | Blautia hydrogenotrophica DSM 10507 |
| | Blautia producta DSM 3507 |
| | Blautia schinkii DSM 10518 |
| | Clostridium autoethanogenum DSM 10061 |
| | Clostridium carboxidivorans DSM 15243 |
| | Clostridium coskii PTA-10522 |
| | Clostridium ljungdahlii DSM 13528 |
| | Clostridium scatologenes DSM 757 |
| | Sporomusa acidovorans DSM 3132 |
| | Eubacterium limosum ATCC 8486 |
| | Acetobacterium woodii DSM 1030; |
| | Sporomusa silvacetica DSM 10669; |
| | M. thermoacetica DSM 1974 |
| | Clostridium magnum DSM 2767 |
| | Acetitomaculum ruminis DSM 5522 |

TABLE 3
Non-limiting examples of compounds or microorganisms
that promote hydrogen consumption in the rumen

| Category | Non-limiting Examples |
|---|---|
| Nitrate | — |
| Sulfate | — |
| Nitrocompounds | 3-nitropropionate |
| | 2-nitropropanol |
| | 2-nitroethanol |
| | Nitroethane |
| Propionate precursors | Malate |
| | Acrylate |
| | Oxaloacetate |
| | Fumarate |
| Yeast | Saccharomyces spp. |

Substrate is added in all cases. Substrate is dried at 60° C. and milled through 1 mm screen. A suitable quantity of substrate is added in each fermentation vial (e.g. 500 mg dry substrate for 50 ml culture media in 120 ml fermentation vials).

Strained rumen fluid (SRF) is collected and maintained anaerobically at 39° C.

Fermentation buffer is prepared, oxygen removed (e.g. by continuous gassing with CO₂) and heated to 39° C. SRF is added in a suitable proportion,—e.g. 1-part SRF per 4 parts of buffer—to make the culture media. Fermentation vials are anaerobically dispensed with culture media (e.g. 50 ml).

Right after culture media is dispensed, additives are added to the media as applicable following the inclusion levels specified above. Gas pressure in the vial headspace is recorded by periodic manual readings employing a pressure transducer, or alternatively an automatic (continuous) system. At several time points during the fermentation (e.g. 6, 12, 18, 24 h) gas is sampled and analyzed for H₂, CH₄ and CO₂ in a gas chromatograph following standard methods. Gas can be directly analyzed upon collection or alternatively can be collected into a vacuum tube for later analysis.

At several time points during the fermentation (e.g. 6, 12, 18, 24 h) fermentation media are sampled to be later analyzed for VFA and other metabolites. Samples for VFA analyses are deproteinized (e.g. 0.8 ml sample is mixed with 0.5 ml of a solution containing 20 g/l metaphosphoric acid in 0.5N HCl and centrifuged at 15000×g at 4° C. for 15 min) and the supernatant is preserved by freezing prior to analyses. An internal standard (e.g. 4 g/l crotonic acid) can also be added. Samples are analyzed for VFA following standard methods, e.g. by gas or liquid chromatography.

After a suitable time (e.g. 24 h), gas pressure is read, and fermentation is stopped (e.g. by placing vials on ice). A sample of gas is collected (e.g. into vacuum tubes). Alternatively, gas can be directly analyzed. Gas is analyzed for H₂, CH₄, and CO₂ concentrations. Vials are then opened and a sample of the liquid is taken for VFA analyses as described above.

Finally, the whole vial contents are processed to estimate substrate disappearance, e.g. filtering through sintered crucibles pore number 1. Residues are oven dried at 60° C. for 48 h, and the dry residue is then removed from microbial contamination by detergent washing (e.g. by weighing into F57 ANKOM filter bags and washing with neutral detergent at 100° C. for 1 h in an ANKOM fiber analyzer). The residues remaining into the bags are weighed for estimating DM and neutral detergent fiber (NDF) disappearance.

### Results

The concentration and/or absolute volume of CH₄, and/or relative volume of CH₄ produced (either per unit of fermentation end-product (e.g. VFA) or per unit of substrate fermented) is assessed.

The change in the concentration and/or absolute accumulation of VFA, particularly acetic acid, and/or the relative accumulation of VFA, particularly acetic acid (either per unit of fermentation gas or unit of substrate fermented) is assessed.

The change in the absolute disappearance of substrate, or in the relative disappearance per unit of fermentation gas or fermentation end-product (e.g. VFA) is assessed.

### Example 2: Effect of the Combination of Methane Inhibitors with Acetogenic Bacteria on Gas Production and Composition, and VFA Production from In Vitro Rumen Incubations

Three-nitrooxypropanol (3NOP) was sourced from CymitQuímica, S.L. (C/Pamplona 96-104, Local 15, 08018, Barcelona, Spain). Freeze-dried Asparagopsis taxiformis (FDAT) was supplied by seaExpert—Consultoria na Areas das Pescas Lda. (Travessa do Farrobim 15, 9900-361 Horta-Açores, Portugal). Acetogenic bacterial strains (Blautia producta (DSM 2950) and Acetobacterium woodii (DSM 1030)) were sourced from Leibniz-Institut DSMZ GmbH (Inhoffenstraße 7B, 38124 Braunschweig, Germany).

In vitro rumen incubations were set up as follows: rumen contents were obtained from 1 of 5 rumen cannulated sheep before the morning feeding and filtered through a double layer of muslin. Rumen fluid was diluted 1:2 in buffer (Menke and Steingass, 1988), and aliquots of 50 ml were added anaerobically to 120 ml Wheaton bottles containing 0.5 g of a 50:50 forrage: concentrate diet, previously ground to pass through a 1-mm² mesh screen. Treatments consisted of (1) control incubations (diet only), and incubations of diet plus (2) 5 ml of live acetogenic strain culture, (3) FDAT+autoclaved acetogenic culture, (4) 3NOP+autoclaved acetogenic culture, (5) combination of FDAT with 5 ml live acetogenic culture, and (6) combination of 3NOP with 5 ml live acetogenic culture. Autoclaved acetogenic cultures were added to treatments 3 and 4 to correct for any potential impacts of the culture products added together with the live strains in treatment 2, 5 and 6. Additionally, a blank bottle (rumen fluid+buffer only) per sheep was included to correct for basal gas and VFA production. In all cases 3NOP was dosed at 0.1% in diet dry matter (0.5 mg per bottle) and FDAT was added at a concentration of 2.0% in the diet dry matter (10 mg FDAT with 490 mg of diet)

Bottles were sealed and incubated at 39° C. Live or autoclaved acetogenic cultures were inoculated 3 h after starting the incubations. Gas was measured after 6 h and 24 h of incubation: gas was released, and a sample was taken for methane and hydrogen analysis. At 24 h bottles were opened, pH measured, and a subsample collected for the determination of volatile fatty acids (VFA) by gas chromatography (Stewart and Duncan, 1985, Journal of General Microbiology 131:427-435).

Two separate experiments were run, each involving one of the two acetogenic strains, and they were separately analyzed. Every experiment comprised 5 replicates (5 sheep). Treatment effects were analyzed by randomized block ANOVA, with individual sheep as blocking term. When significant effects were detected across treatments, means were compared by Fisher's protected LSD test, and P values for the following contrasts were requested: (1) control vs acetogenic strain, (2) FDAT vs FDAT+acetogenic strain, and (4) 3NOP vs 3NOP+acetogenic strain. Genstat 23th Edition (VSN International, Hemel Hempstead, UK) was used.

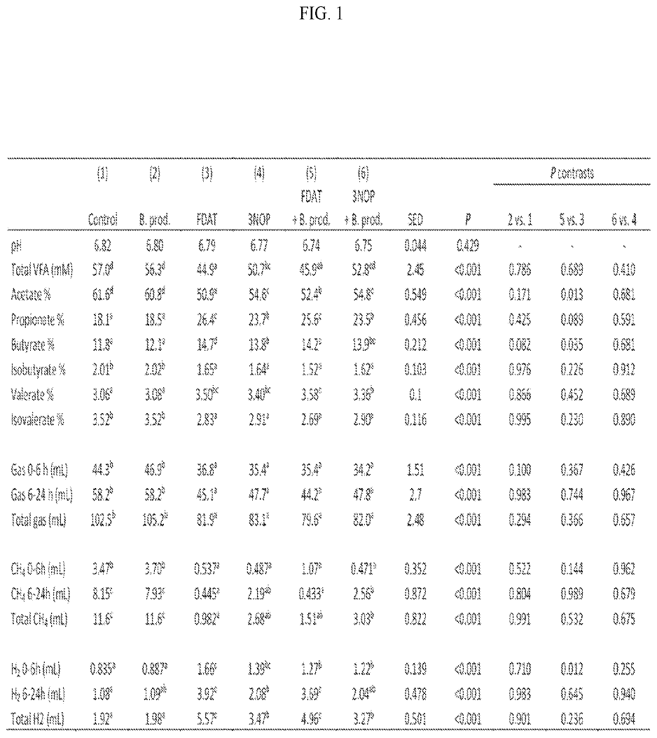

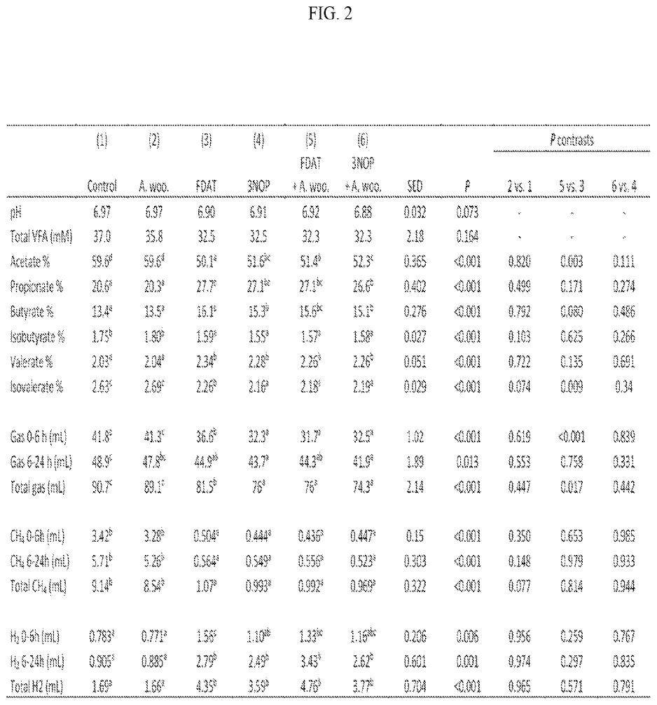

Results for the incubations with B. producta and corresponding combinations (Experiment 1) are reported in FIG. 1, while results for A. woodii (Experiment 2) are reported in FIG. 2.

Experiment 1: There was a marked decrease in methane produced by both methane inhibitors FDAT (−92% after 24 h) and 3NOP (−77% after 24 h), with FDAT showing a greater inhibition than 3NOP in this experiment. Accordingly, the increase in accumulated hydrogen was also greater for FDAT (+190% after 24 h) compared to 3NOP (+81% after 24 h). Total VFA decreased: −21% less with FDAT, and −11% less with 3NOP, mostly at the expense of acetate. B. producta, alone, did not impact any of the fermentation results. However, when combined with FDAT, B. producta did not affect the inhibition in methane caused by FDAT while causing a significant increase in the proportion of acetate (+5% calculated total acetate), as well as a decrease of −23% in hydrogen accumulated after 6 h of incubation. No interactions were observed for B. producta with 3NOP, probably because of the lower effect on methane of 3NOP vs. FDAT in this experiment, as previously indicated.

Experiment 2: Similar to Exp. 1, A. woodii, alone, did not cause significant changes in fermentation parameters, but when combined with FDAT acetate proportion increased with no change in methane inhibition. No statistical effect was found on the production of individual gases for the combination vs. FDAT alone, but total gas was decreased-10% when A. woodii was added on top of FDAT. Contrary to experiment 1, in this experiment FDAT and 3NOP had individually a similar impact on methane production (−88 to −89% after 24 h) and hydrogen accumulation (112-157% after 24 h), and interestingly the proportion of acetate increased or tended to increase to a similar extent when A. woodi was added to either FDAT or 3NOP cultures.

We claim:

1. A ruminant feed additive or feed composition comprising (a) one or more rumen inhibitor compounds; and (b)(1) one or more acetogenic bacteria; and/or (2) one or more compounds that promote hydrogen consumption in the rumen.

2. The feed additive or feed composition of claim 1, wherein the rumen inhibitor compound comprises one or more of a nitrooxy compound, a coenzyme M analog, a pterin compound, a hydroxymethylglutaryl-CoA reductase inhibitor, an antimicrobial peptide, or a plant secondary metabolite.

3. The feed additive or feed composition of claim 1 or claim 2, wherein the rumen inhibitor compound comprises 3-Nitrooxypropanol (3NOP) or a coenzyme M analog.

4. The feed additive or feed composition of any one of claims 1-3, wherein the one or more acetogenic bacteria is one or more bacteria selected from the group consisting of Acetobacterium bakii, Blautia hydrogenotrophica, Blautia producta, Blautia schinkii, Clostridium autoethanogenum, Clostridium carboxidivorans, Clostridium coskii, Clostridium ljungdahlii, Clostridium scatologenes, Sporomusa acidovorans, Eubacterium limosum, Acetobacterium woodii, Sporomusa silvacetica, Moorella thermoacetica, Acetitomaculum ruminis, Ruminococcus productus, and Clostridium magnum.

5. The feed additive or feed composition of any one of claims 1-4, wherein the one or more compounds that promote hydrogen consumption in the rumen comprises one or more of a nitrate, sulfate, nitrocompound, or propionate precursor.

6. The feed or feed additive composition of any one of claims 1-5, further comprising one or more enzymes.

7. The feed or feed additive composition of claim 6, wherein the enzyme comprises a glucoamylase and/or a phytase.

8. A method for reducing the production of methane emanating from the digestive activities of ruminants and/or for improving ruminant animal performance comprising orally administering to the animal an effective amount of the feed additive or feed composition of any one of claims 1-7.

9. The method of claim 8, wherein the ruminant animal is selected from the group consisting of: beef cattle, dairy cattle, veal, goats, sheep, giraffes, American Bison, European bison, yaks, water buffalo, deer, camels, alpacas, llamas, wildebeest, antelope, pronghorn, and nilgai.

10. The method of claim 8 or claim 9, wherein the hydrogen concentration in the rumen of the animal is less than 5%.

11. The method of any one of claims 1-10, wherein the feed additive or feed composition is not pretreated using wet explosion pretreatment.

12. A method for producing a feed additive or feed composition comprising combining (a) one or more rumen inhibitor compounds; and (b)(1) one or more acetogenic bacteria; and/or (2) one or compounds that promote hydrogen consumption in the rumen.

13. The method of claim 12, wherein the rumen inhibitor compound comprises one or more of a nitrooxy compound, a coenzyme M analog, a pterin compound, a hydroxymethylglutaryl-CoA reductase inhibitor, an antimicrobial peptide, or a plant secondary metabolite.

14. The method of claim 12 or claim 13, wherein the rumen inhibitor compound comprises 3-Nitrooxypropanol (3NOP) or a coenzyme M analog.

15. The method of any one of claims 12-14, wherein the one or more acetogenic bacteria is one or more bacteria selected from the group consisting of Acetobacterium bakii, Blautia hydrogenotrophica, Blautia producta, Blautia schinkii, Clostridium autoethanogenum, Clostridium carboxidivorans, Clostridium coskii, Clostridium ljungdahlii, Clostridium scatologenes, Sporomusa acidovorans, Eubacterium limosum, Acetobacterium woodii, Sporomusa silvacetica, Moorella thermoacetica, Acetitomaculum ruminis, Ruminococcus productus, and Clostridium magnum.

16. The method of any one of claims 12-15, wherein the one or more compounds that promote hydrogen consumption in the rumen comprises one or more of a nitrate, sulfate, nitrocompound, or Propionate precursor.

17. The method of any one of claims 12-16, further comprising combining one or more enzyme with the feed additive or feed composition.

18. The method of claim 17, wherein the enzyme comprises one or more of a glucoamylase, xylanase, amylase, phytase, beta-glucanase, fucosidase, and/or protease.

19. The method of any one of claims 12-18, further comprising packaging the feed additive or feed composition.

20. The method of any one of claims 12-19, wherein the feed additive or feed composition is not pretreated using wet explosion pretreatment.
